(19) United States
(12) Patent Application Publication
(10) Pub. No.: US 2017/0089499 A1
(43) Pub. Date: Mar. 30, 2017

(54) SWIVEL DEVICE

(71) Applicant: Indexator Rotator Systems AB, Vindeln (SE)

(72) Inventor: Joakim Harr, Vindeln (SE)

(73) Assignee: Indexator Rotator Systems AB, Vindeln (SE)

(21) Appl. No.: 15/310,831

(22) PCT Filed: May 26, 2015
(86) PCT No.: PCT/SE2015/050602

§ 371 Date: Nov. 14, 2016

(30) Foreign Application Priority Data
May 28, 2014 (SE) 1400270-3

(51) Int. Cl. F16L 27/08

(52) U.S. Cl. CPC F16L 27/0816

(57) ABSTRACT

The present invention relates to a swivel device (10) for connection of two conduits or hoses which are rotatable in relation to each other, wherein the device (10) comprises a first centre part (20) provided with a hole, which first centre part (20) has a first fastening portion (22) for attachment of a first conduit, and a second centre part (30) provided with a hole, which second centre part (30) has a second fastening portion (32) for attachment of a second conduit, wherein the first centre part (20) and the second centre part (30) are rotatable in relation to each other, wherein: the centre parts (20, 30) are mutually held together by means of an outer sleeve (150) which in one of its ends is anchored to the second centre part (30) and which in its other end is rotationally slidably arranged in relation to the first centre part (20), a tube part (40) is arranged inside the swivel device (10) in order to cover a gap (50) between the first centre part (20) and the second centre part (30), a first axial slide bearing (140) is arranged between the outer sleeve (150) and the first centre part (20), wherein the first axial slide bearing (140) comprises a slide bearing (141), and a second axial slide bearing (190) is arranged between the first centre part (20) and the second centre part (30).

### TECHNICAL FIELD

The present invention relates to a swivel device according to the independent claim 1.

### BACKGROUND OF THE INVENTION

So called swivels or swivel devices are used when it is desired to transfer a medium, for example hydraulic oil, between two conduits/tubes/hoses which rotate in relation to each other or which are rotatable in relation to each other.

The Swedish Patent SE 535654 shows a swivel device according to the prior art. Said swivel device comprises a radial hole for leakage of hydraulic oil. The hole is arranged for providing a medium under pressure and to lubricate an axial bearing. Furthermore, a ring shaped recess is arranged inside the outer casing in order to facilitate communication of pressurised medium between the hole and the axial bearing.

A drawback with the hole connection according to above is that the volume where the hydraulic oil is conducted have to be sealed with at least two sealings. These sealings have a larger diameter than the two smaller which are arranged on the centre tube and thus become very hard to seal. With larger diameters on a rotating sealing the sliding speed increases and thereby also the temperature due to the friction which shortens the life of the sealing. Measures to solve this problem, such as making the surface against which the sealings slide, very smooth (i.e. the surface finish) is both costly and difficult to implement.

### SUMMARY OF THE INVENTION

An object of the present invention is to provide a swivel device which completely or partly solves the problem with swivel devices according to the prior art.

This object is achieved by a swivel device for connection of two conduits or hoses which are rotatable in relation to each other, wherein the device comprises a first centre part provided with a hole, which first centre part has a first fastening portion for attachment of a first conduit, and a second centre part provided with a hole, which second centre part has a second fastening portion for application of a second conduit, wherein the first centre part and the second centre part are rotatable in relation to each other, wherein:
the centre parts are mutually held together by means of an outer sleeve which in one of its ends is anchored to the second centre part and which in its other end is rotationally slidably arranged in relation to the first centre part,
a tube part is arranged inside the swivel device in order to cover a gap between the first centre part and the second centre part,
a first axial sliding bearing is arranged between the outer sleeve and the first centre part, wherein the first axial sliding bearing comprises a sliding bearing element, and
a second axial sliding bearing is arranged between the first centre part and the second centre part.

Embodiments of the swivel device according to the present invention are defined in the appended independent claims.

With a solution according to the invention a swivel device is provided which is cheaper to manufacture as the present swivel device does not comprise a hole connection according to the prior art. This means that manufacturing costs and component costs for sealings may be decreased. Furthermore, the life is increased.

Furthermore, with a device according to the present invention the inner surfaces of the outer sleeve may be somewhat coarser as no sealings have to slide against these which lead to that a further reduction in manufacturing costs.

Additional advantages with a swivel device according to the invention are that fewer sealings decrease the risk for leakage, and furthermore the assembly of the swivel device becomes easier as said sealings have proved to be difficult to assemble.

Additional advantages and areas of use will be apparent from the following description.

### SHORT DESCRIPTION OF THE DRAWINGS

In the following embodiments of the invention will be described with reference to the appended drawings, on which:

FIG. 1 shows in a longitudinal cut an embodiment of the present invention; and

FIG. 2 shows the embodiment according to FIG. 1 in a perspective view.

### DETAILED DESCRIPTION

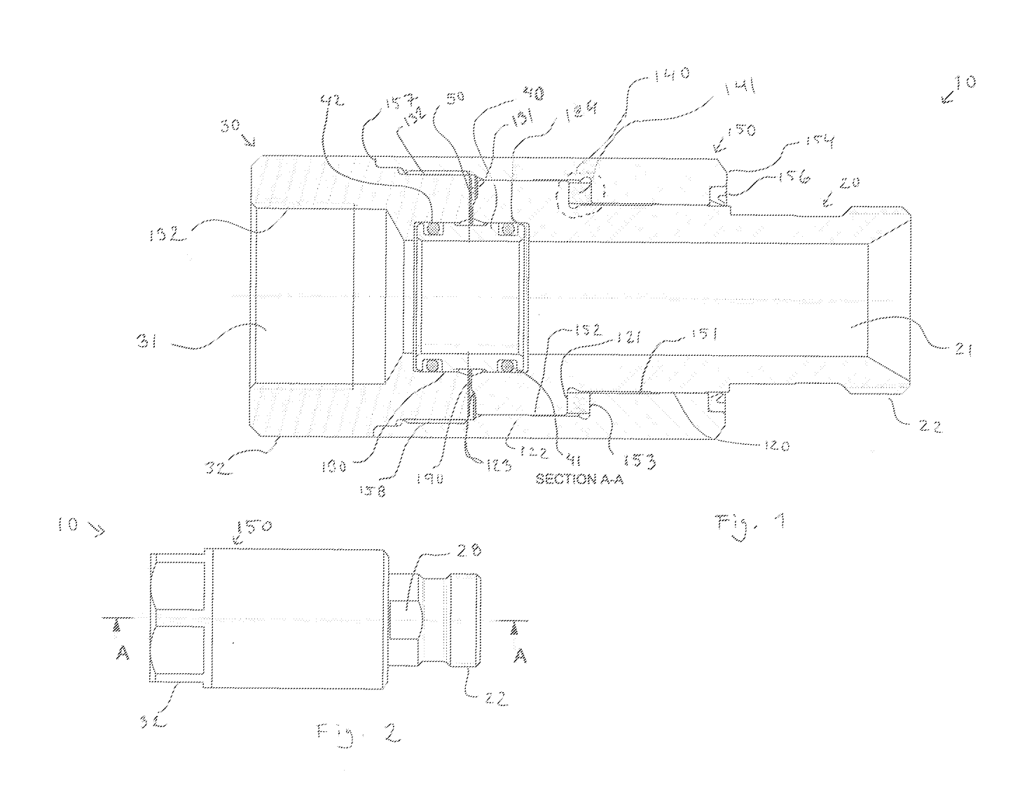

FIGS. 1 and 2 show an embodiment of the present invention. The swivel device 10 shown in FIGS. 1 and 2 comprises a first centre part 20 and a second centre part 30 and an outer sleeve/connecting part 150 acting between said parts 20, 30.

The first centre part 20 comprises a circular centre hole 21 and has in this example a threaded fastening portion 22 for attachment of a first connection hose (e.g. a hydraulic hose) via a connection device. Furthermore, the first centre part 20 has a circular first step 120 which via a shoulder 121 changes into a circular second step 122 which ends with an end portion 123 which is turned away from its end portion comprising the fastening portion 22. The step 122 exhibits a circular recess 124 at its end portion 123. The first centre part 20 also exhibits a key grip 28 to facilitate the assembly.

The second centre part 30 comprises a circular centre hole 31 corresponding to the centre hole 21 of the first centre part 20, and has in this example a threaded fastening portion 32 for attachment of a second hose via a connection device. Furthermore, the second centre part 30 exhibits a circular recess 130 in its end portion 131 turned away from the fastening portion 32. The second centre part 30 also has a thread portion 132 arranged on the inside. Furthermore, the second centre part 30 has a key grip 39 to facilitate assembly.

According to the invention a circular sleeve or a circular tube 40 is arranged in the recesses 124 and 130 as is evident from FIG. 1. The sleeve/tube 40 bridges a gap 50 which is present between the end portions 123 and 131. As is shown in FIG. 1 the sleeve 40 has a dimension which is essentially the same as the dimensions for the centre hole 21, 31, of the first and the second part. The sleeve 40 results in that the gap 50 becomes covered, which is very advantageous from an axial load point of view as the pressure medium cannot exert a dividing pressure on the end portions (end planes) 123 and 131. The socket 40 may for example be manufactured from stainless steel and the first centre part 20, the second centre part 30 and the outer socket 150 may be manufactured from steel which has been anti-corrosive treated by hardening.

Between the sleeve 40 and the recesses 124 and 130 sealings 41, 42, are arranged to prevent that the pressure medium reaches the gap 50. The sealings 41, 42 are arranged in outside grooves of the sleeve/tube 40. The sleeve 40 cooperates in a sliding bearing manner with the surrounding portions 124 and 130 of the first and second centre part why the sleeve 40 is arranged rotatable in relation to the first 20 and the second 30 centre part according to an embodiment. According to another embodiment the sleeve 40 is arranged rotatable in relation to the first 20 or the second 30 centre part, i.e., attached to any one of the first 20 or the second 30 centre part.

Furthermore, the swivel device 10 comprises a first axial sliding bearing 140 which is arranged to carry thrust loads of the swivel device. Also the end portions 123 and 131 at the gap 50 are arranged to carry thrust loads for some load cases and to serve as a second axial slide bearing 190.

According to the present invention the first axial slide bearing comprises an (axial-) slide bearing element 141. The purpose of the slide bearing element 141 is mainly to carry the thrust loads of the swivel device.

According to another embodiment, which is also shown in FIG. 1, the slide bearing element 141 is a separate element and manufactured from a different material than the first centre part or the outer sleeve 150. It has turned out that polymer material is particularly suitable with good properties but also metal works well. The advantage with plastic is that it is very cost efficient and easy to manufacture slide bearing elements of this material.

According to another embodiment the slide bearing element 141 is detachably (replaceably) arranged at the first axial slide bearing 140. The advantage of this is for example that the slide bearing element 141 may be replaced due to wear.

Furthermore, the slide bearing element 141 extends along the outer circumference of the first centre part 20 at the first axial slide bearing 140, which is also shown in FIG. 1.

The swivel device further comprises a circular outer sleeve 150 with a nut function arranged to hold together the components of the swivel device 10 as is evident from FIG. 1. The outer sleeve 150 exhibits two circular shoulders 151, 152 and a shoulder 153 arranged between them. The slide bearing element 141 is arranged between the shoulder 153 of the sleeve and the shoulder 121 of the first centre part.

In its first end 154 the outer sleeve 150 also exhibits a recess for a sealing 156. At its second end 157 the outer sleeve 150 has an internal thread 158 which co-operates with the thread portion 132 of the second centre part 30 so that a suitable tightening may be performed. The outer sleeve 150 exhibits an outer key grip 159.

A slide bearing function is provided between the respective peripheral surfaces of the steps 120 and 122, respectively, and the step surfaces of the outer sleeve which rest against them, which thereby form a first and a second radial bearing at the steps 120 and 122, respectively. The positioning of the first axial slide bearing 140, and thus also the slide bearing element 141, affects the “size” of the first and second radial bearing as a displacement of the first axial slide bearing to the left in FIG. 1 leads to that the size of the first radial bearing decreases (or completely disappears) and alternatively a displacement of the first axial slide bearing to the right in FIG. 1 leads to that the size of the second radial bearing decreases. According to the embodiment that is shown in FIG. 1 the first axial slide bearing is positioned so that the first and the second radial bearing have approximately the same size to provide a balance at radial loads of the device 10.

The swivel device 10 according to the inventive constructive concept becomes very easy to rotate.

Sealing grooves are arranged on the outside, which is easier from a manufacturing and assembly point of view. It should be realized that the number of sealings naturally may be varied according to the need.

In connection with the assembly of the swivel device 10 sufficient greasing of the parts involved is of course performed. In particular this is true for the slide bearing element 141 which is greased once at assembly at the first axial slide bearing 140.

Furthermore, it should be realized that the design of the components of the swivel device 10, such as, e.g., the attachment portions, naturally may be varied within the scope of the present inventive idea.

The invention is not limited to what has been shown and described, but amendments and modifications are of course possible within the scope of the appended claims.

1. Swivel device for connection of two conduits or hoses which are rotatable in relation to each other, wherein the device comprises a first center part provided with a hole, which first center part has a first fastening portion for attachment of a first conduit, and a second center part provided with a hole, which second center part has a second fastening portion for attachment of a second conduit, wherein the first center part and the second center part are arranged mutually rotatable, wherein:
the center parts are mutually held together by means of an outer sleeve which in one of its ends is anchored to the second center part and which in its other end is rotationally slidably arranged in relation to the first center part,
a tube part is arranged inside the swivel device in order to cover a gap between the first center part and the second center part,
a first axial slide bearing is arranged between the outer sleeve and the first center part, wherein the first axial slide bearing comprises a slide bearing element, and
a second axial slide bearing is arranged between the first center part and the second center part.

2. Swivel device according to claim 1, wherein the first center part is axially displaceable between a first position in which the first axial slide bearing is active and a second position in which the second axial slide bearing is active.

3. Swivel device according to claim 1, wherein the gap enables a limited axial movement between the first center part and the second center part.

4. Swivel device according to claim 1, wherein the tube part is detachably arranged inside the swivel device.

5. Swivel device according to claim 1, wherein the tube part is attached to or is a part of the first center part or the second center part.

6. Swivel device according to claim 1, wherein the slide bearing element is a separate slide bearing element.

7. Swivel device according to claim 6, wherein the slide bearing element is detachably/replaceably arranged at the first axial slide bearing.

8. Swivel device according to claim 6, wherein the slide bearing element is annular and extends along the outer circumference of the first center part at the first axial slide bearing.

9. Swivel device according to claim 6, wherein the slide bearing element is lubricated once at assembly of the first axial slide bearing.

10. Swivel device according to claim 6, wherein the slide bearing element is manufactured from a polymer material or from metal such as bronze, brass, or a copper alloy.

11. Swivel device according to claim 1, wherein the tube part is arranged rotatable in relation to the first center part and/or the second center part.
